(19) United States
(12) Patent Application Publication
(10) Pub. No.: US 2015/0310149 A1
(43) Pub. Date: Oct. 29, 2015

(54) ESD/EOS SYSTEM LEVEL SIMULATION TOOL

(71) Applicant: Pragma Design, Inc., Bertram, TX (US)

(72) Inventor: Jeffrey C. Dunnihoo, Bertram, TX (US)

(21) Appl. No.: 14/698,902

(22) Filed: Apr. 29, 2015

Related U.S. Application Data
(60) Provisional application No. 61/986,045, filed on Apr. 29, 2014.

(51) Int. Cl. G06F 17/50; G06F 17/10

(52) U.S. Cl. CPC G06F 17/5018; G06F 17/10

(57) ABSTRACT

Disclosed are exemplary embodiments of methods and systems for numerical simulation of Electrostatic Discharge (ESD) and Electrical Overstress (EOS) events applied to one or more component devices under test or devices under protection. In an example embodiment, a method generally includes providing access to centralized resources for industry standard nodal circuit or finite element analysis numerical simulation of electromagnetic events, as well as protecting intellectual property for some or all of the numerical models used in the simulation. In an exemplary embodiment, a numerical simulation system provides a platform for multiple users to utilize this platform simultaneously, select independent combinations of models and simulation parameters, execute these simulations and view, and store and retrieve these results independently. With such a simulation platform, a central or distributed repository of protected device models can be used as “black boxes” by system integrators to compare and contrast results in various combinations.

### CROSS-REFERENCE TO RELATED APPLICATION

This application claims the benefit of U.S. Provisional Application No. 61/986,045, filed on Apr. 29, 2014. The entire disclosure of the above application is incorporated herein by reference.

### FIELD

The present disclosure relates generally to ESD/EOS (electrostatic discharge/electrical overstress) system level simulation.

### BACKGROUND

This section provides background information related to the present disclosure which is not necessarily prior art.

Currently, there are a number of solutions for ESD/EOS system level simulations. Some of these solutions attempt to provide the same benefits described presently. But as recognized by the inventor hereof, these solutions fail to meet the needs of the industry for several reasons. Firstly, these solutions rely on the component vendors to distribute accurate representations of their devices, which may include disclosing trade secret or other proprietary information to competitors. Secondly, these solutions rely on the system designer, who while having sufficient skills for the optimization of their design in functionality and performance, may not necessarily have extensive skills and background in high-current, fast rise time ESD (electrostatic discharge) and EOS (electrical overstress) failure mechanisms. Thirdly, such simulations inherently lead the system designer to choose certain devices and eschew others based on the performed analysis. And, the component vendor might be applying capital and resources to delivering models, which are being used incorrectly by customers to decide against their products, for valid or potentially erroneous reasons.

Other solutions attempt to simplify the selection process by simply approximating component performance in a non-specific circuit or system. But the inventor hereof has also recognized that these other solutions are similarly unable to meet the needs of the industry. This is because system ESD/EOS issues are inherently related to the interactions of multiple components, and therefore, parameters based on a single component may not be applicable in any situation where the component is used in combination with other devices.

Still other solutions seek to provide restricted solutions for only one vendor or a limited selection of components. But the inventor has recognized that these solutions also fail to meet industry needs. This is because innovative designers routinely introduce the latest devices into their systems for maximum performance and functionality. Therefore, such a solution which cannot be rapidly augmented with incrementally new models for individual components cannot keep up with the pace of development.

It is presently possible to simulate ESD/EOS event interactions with existing available proprietary or open-source circuit or Finite Element Method (FEM) simulators such as SPICE or HFSS. This may be done by utilizing accurately characterized electrical models of devices and circuit board interconnects relevant to high-current, high-voltage transients. The inventor hereof has recognized that it would be desirable to provide access to such computational resources without dedicated installations of proprietary software for the user, without the associated extensive computational server hardware requirements and associated costs, and without licensing and training costs associated with universally flexible and capable simulation systems. The inventor hereof has further recognized that it would be further desirable that capital intensive test and measurement and characterization hardware not be required to develop individual models for each component under investigation.

The inventor hereof has also recognized that it would be desirable to take advantage of a central, independent, expert Center-of-Competency in ESD/EOS modeling and simulation and verification to validate simulation input and output, thus avoiding wasted “Garbage In, Garbage Out” transactions which may be created by invalid assumptions. It would further be desirable to have this arbitration done independently such that competing component providers would not skew their model definitions for competitive advantage. It would be ultimately satisfying to the needs of industry in this area to access this entire central computational resource from an existing computer or smartphone connected to a local network or the Internet, such that they could compare and contrast differing ESD/EOS protection and performance options, and accurately select the most appropriate components not only in the early product design environment, but also at the sustaining and manufacturing phase and even at vendor meetings during pricing discussions.

### SUMMARY

This section provides a general summary of the disclosure, and is not a comprehensive disclosure of its full scope or all of its features.

Disclosed are exemplary embodiments of methods and systems for numerical simulation of Electrostatic Discharge (ESD) and Electrical Overstress (EOS) events applied to one or more component devices under test or devices under protection. In an example embodiment, a method generally includes providing access to centralized resources for industry standard nodal circuit or finite element analysis numerical simulation of electromagnetic events, as well as protecting intellectual property for some or all of the numerical models used in the simulation. In an exemplary embodiment, a numerical simulation system provides a platform for multiple users to utilize this platform simultaneously, select independent combinations of models and simulation parameters, execute these simulations and view, and store and retrieve these results independently. With such a simulation platform, a central or distributed repository of protected device models can be used as “black boxes” by system integrators to compare and contrast results in various combinations.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a typical outline of the elements required to perform an ESD/EOS simulation.

FIG. 2 shows a typical block diagram of the distributed software architecture.

FIG. 3 shows a specific ESD/EOS simulation tool partitioned to enable desirable operational advantages for the end user and component supplier.

FIG. 4 shows an exemplary embodiment of ESD/EOS simulation tool and example input parameters.

FIGS. 5A through 5C show example simulation results that were produced using the input parameters shown in FIG. 4. The simulation results include indications of whether the device under test (DUT) passed or failed, device under protection (DUP) passed or failed, and power and energy plots.

### DETAILED DESCRIPTION

Example embodiments will now be described more fully with reference to the accompanying drawings.

Example embodiments include or relate to a collection of data libraries, particular test and measurement characterization methodologies used to create the data libraries, software programs to manipulate, process and report results, and a user interface architecture, which coherently organizes users by accounts, model access privileges and visibility, and controls usage limits as well as provides optional instant context relevant training and explanatory information.

The user interface provides a concise, limited, but highly configurable input method, which allows users to choose from basic component models available to all users, private models available only under their account access, and shared models which are available to one or more groups of user accounts. Applied test pulse type and intensity, repetition, etc. may be selected by the user. Options for uploading local models or selecting model parameters may also be made available. Circuit board interconnect and load models may be selected through this interface. These selections, when run are compiled into a common circuit or finite element model (FEM) input description file, which is executed on a central computation facility (which may comprise one or more distributed computing networks beneath this logical level). The subsequent output of these simulations is then organized into meaningful presentation format (e.g., web page with graphics, PDF report, etc.) and returned specifically to the user confidentially for storage, analysis, and/or for modifying the inputs and running a new iteration if account statistics and privileges allow.

Example embodiments may also provide one or more of the following options, including analysis of selectable test pulse types as defined by the user or by various industry standards associated with component level ESD/EOS (Machine Model (MM), Charged Device Model (CDM), Human Body Model (HBM), Human Metal Model (HMM), Transmission Line Pulser (VF-TLP/TLP), system level ESD/EOS (IEC61000-4-2), lightning/surge pulses (IEC61000-4-5), electrical fast transients (EFT/IEC61000-4-4), induced and conducted RF fields, voltage dips and dropouts (IEC61000-4-11), etc.

To facilitate ease of use, circuit and system topologies may be constrained to as simple as a single test pulse generator and a single Device Under Test (DUT) connected through a single virtual simulation node. Additional topologies may be allowed that include one or more pulse inputs, one or more DUTs, one or more interconnect models and device elements in series, and one or more Devices Under Protection (DUPs) all of which may have independent models with unique response characteristics, failure limits and failure modes (e.g., peak voltage, peak current, total energy, dissipated power, electromagnetic field (EMF), thermal breakdown, etc.). Alternative analysis modes may include the stepping or sweeping of desired parameters (e.g., pulse voltages, pulse repetitions, resistor values, transmission line length, etc.) or combinatorial analysis of component interactions (e.g., DUT_A with DUP_C, DUT_B with DUP_D, DUT_A with DUT_D, etc.) to rapidly identify optimal component selection and/or predict overall system robustness, which might not be apparent when components are considered on their own merits. Along with selecting existing models from the libraries, users may also enter components that are not yet included in the library, and these may, by popularity and availability, be queued for offline analysis and characterization to be added to the library, at which time the desired analyses can be performed and reported to the requester automatically for their review.

Example embodiments disclosed herein are unique when compared with other known devices and solutions at least because they provide: (1) a multitude of failure modes and mechanisms can be conveniently monitored and analyzed simultaneously; and (2) end-user system designers, sustaining engineers, and product marketing specialists can extract accurate relevant pass/fail results but need not be skilled in the specialized field of ESD/EOS transient simulation.

Among other things, example embodiments disclosed herein may provide an ESD/EOS system level simulation tool that does not suffer from any of the problems or deficiencies associated with prior solutions. Example embodiments may segment the architecture of the tool such that elements of the front-end interface and back-end processing can be distributed across multiple network or ownership domain boundaries.

Example embodiments of may partition and isolate the underlying model IP to allow each model used by the system designer to be independent and protected from disclosure while still providing retained control of each component model by its respective contributor.

Example embodiments disclosed herein are directed to an ESD/EOS system level simulation tool. The most complete version of the ESD/EOS system level simulation tool is initiated by a system designer who may have little or no experience with ESD/EOS design or analysis, no special test and measurement equipment, and with perhaps only a personal computer and Internet access to the centralized simulator site. Alternatively, a component supplier, a distributor of multiple preferred suppliers, or an independent third-party unbiased test and measurement facility may host the simulation repository and/or simulation site. Other embodiments are also possible.

The designer's computer establishes an Internet connection with a Web server hosting the user input interface (the “hosting web site”). This website may handle all user login and account administration, as well as provide, or provide a portal to instructional and training videos or documents regarding ESD/EOS simulation and ESD/EOS robustness and training in general.

Based on user login credentials and user or group account information, this site provides the user a private session with tailored model and configuration options and instructions. The hosting web site may also offer a subset of sample models and configurations to anonymous users for limited demonstration purposes. The hosting web site accepts the selections from the user and then passes the request to the back-end server (the “simulation site”) for processing. The hosting site may provide some load balancing and queuing functionality here by querying one or more back-end sites and/or placing the new request in a prioritized processing queue based on load and user credentials.

Multiple unrelated front-end sites may independently access the back-end site, utilizing the same library datasets, but providing completely different user interfaces, library access limitations, simulation complexity, and data output formats.

The back-end simulation site(s) may be implemented on the same hosting web site server or server farm. Or, for additional security or performance reasons, it may be partitioned onto another local, virtual, or remote server or distributed server complex. It may be desirable to partition the computationally intensive back-end simulation processing, the database storage facilities, and the web hosting site one or more various segments and with one or more various communication interfaces, encrypted or otherwise, to achieve the same functionality.

In most commercial instantiations, the content of the models encapsulates the majority of the capital investment of a large library based utility, as manual measurement and creation and validation of the data is labor intensive for skilled specialists. A distributed volunteer community, crowd-sourced or open-sourced library might be preferentially exposed to the end user, who might also be a co-developer, but an open model that allows access to the models would enable a competing for-profit or not-for-profit competitor to copy the entire repository and fork off an identical functional website that would then degrade the value of the original site, and also diminish the consistency of the model variants and version tracking, causing uncertainty in the user community about accuracy of reported results.

Thus, it is preferable to generally provide for the isolation and protection of the model libraries within the back-end simulation site, only to be requested by the hosting site and user via model numbers and/or component names related to a black-box component specification at the highest level. But any combination of exposing some model contents and concealing contents of others may be desirable based on goals and/or user or group credentials.

After receiving the session's simulation configuration request, the back-end server concatenates the selected component models for the system as well as aggressor (zap source) models and other circuit board and interstitial parasitic elements relevant to the simulation. A full-wave 3D simulation or simple SPICE-type nodal transient or other desired analysis is performed, and output waveforms, including failure/upset flags are recorded.

These failure flags are calculated and assessed within each model based on parameters relevant to each particular component. These failure criteria may include for example: instantaneous maximum voltage limits to account for gate oxide breakdown, instantaneous maximum current limits for metallization failure, instantaneous power thresholds and cumulative energy limits for thermal breakdowns or even derivative measurements such as di/dt limits which may not reflect permanent damage, but may indicate a possible latchup or other soft-error condition. Component failure flags may also be generated by monitoring patterns and a recorded history of cumulative events for the particular instantiation of a components, such as “X” number of EFT glitches in a specific period of time, and/or “Y” glitches over a lifetime of the testing period, for example.

These failure flags, however generated internal to the particular model (such as INPUT_OVERCURRENT in a specific BAV99 diode model), are combined and exposed to the system level simulation as generalized signals for the DUT, DUP of PCB where that model is used, such as DUT_FAIL or DUP_FAIL or PCB_FAIL, for example. When a different diode model is selected instead of the BAV99 example above, a “ZENER_OVERVOLT” signal may be the critical failure criteria for that device, and thus this signal is mapped to the generic “DUT_FAIL” signal on the subsequent simulation. Therefore, the status signals particular to the models used are reported in parallel as general flags with respect to the location in the system where they are selected along with the current and voltage values (or field vectors, etc.) and the simulation can continue to the extent of the initially requested period or they may be terminated when one or more failure criteria are met.

Allowing the simulation to proceed beyond failure limits may provide additional information on the failure mechanism, and subsequent damage modes that may be useful to the user in mitigating the impact of damage when it does occur in the actual system, or ideally, to optimize the system design to avoid any failures in the first place. Reporting the fail flags simultaneously in real time with the monitored nodal or vector quantities of a simulation provides the ability to pinpoint the approximate time and levels (vectors and magnitude) in the system where and when a failure occurs. Localizing the failure in time and position helps the user identify the overall failure mechanism.

The simulated system may be as simple as a single device, or it may comprise multiple Input/Output nodes in a module interface, or it could include the entire extent of the system circuit and/or 3D field environment of the system.

The operational loop is completed by returning appropriate results, or comparison of results to the user for further analysis. With multiple brute-force or efficient discrete sorting algorithms selecting combinations of devices from a set of acceptable and available components, the most desirable output may not be related to a pass or fail result for a given system combination, but for the simulation to provide a set or sets of optimal component combinations from the results of many back-end simulations which would otherwise have to be discovered through trial and error.

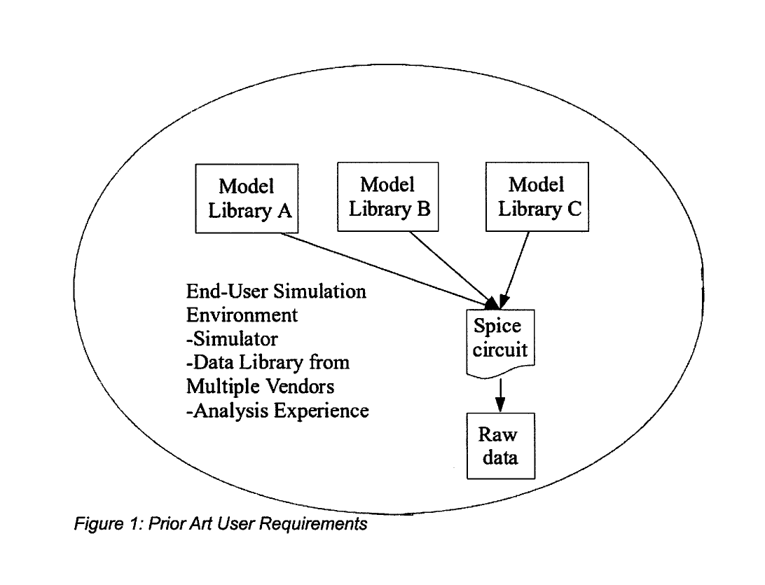

Referring to the figures, FIG. 1 shows the basic components required for an end user to simulate an arbitrary ESD/EOS transient event, including collection of appropriate models from various vendors as required, converting and importing these models into a user provided and acquired simulation software platform compatible with all input models, and finally, appropriate expertise to interpret and extrapolate meaningful component failure information from the raw data which is relevant to the system-level implementation.

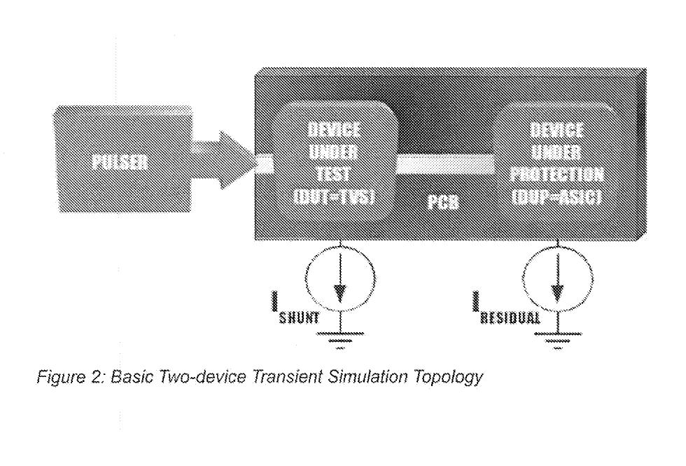

FIG. 2 shows a simple two-component system implementation comprising: an ESD/EOS generating input pulser; a system circuit board further comprising a Transient Voltage Suppressor Protection Device (Device Under Test, “DUT”) an integrated circuit to be protected (Device Under Protection, “DUP”) and all of these elements connected by various impedance/conduction paths described as elements of a Printed Circuit Board (PCB) model.

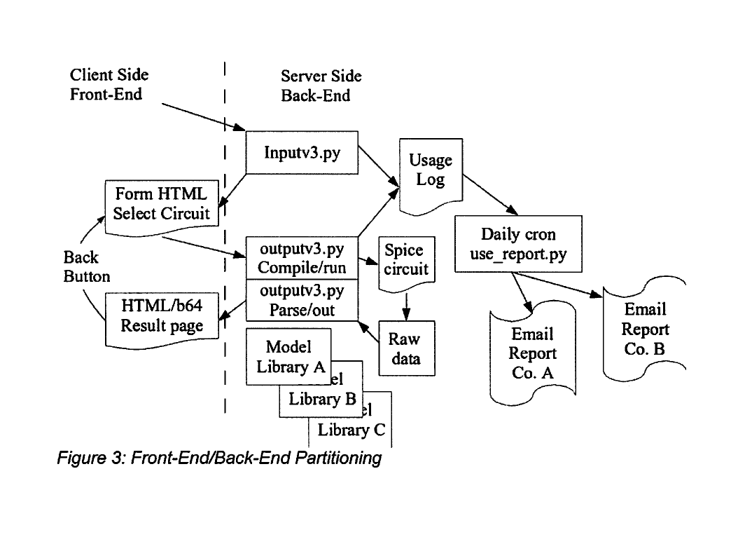

FIG. 3 shows a distributed simulation methodology which allows various partitioning of the basic components shown in FIG. 1 such that the burden on the user is minimized and the exposure of critical IP libraries for the component manufactures is likewise minimized and trade secrets can be more easily protected by an impartial third party.

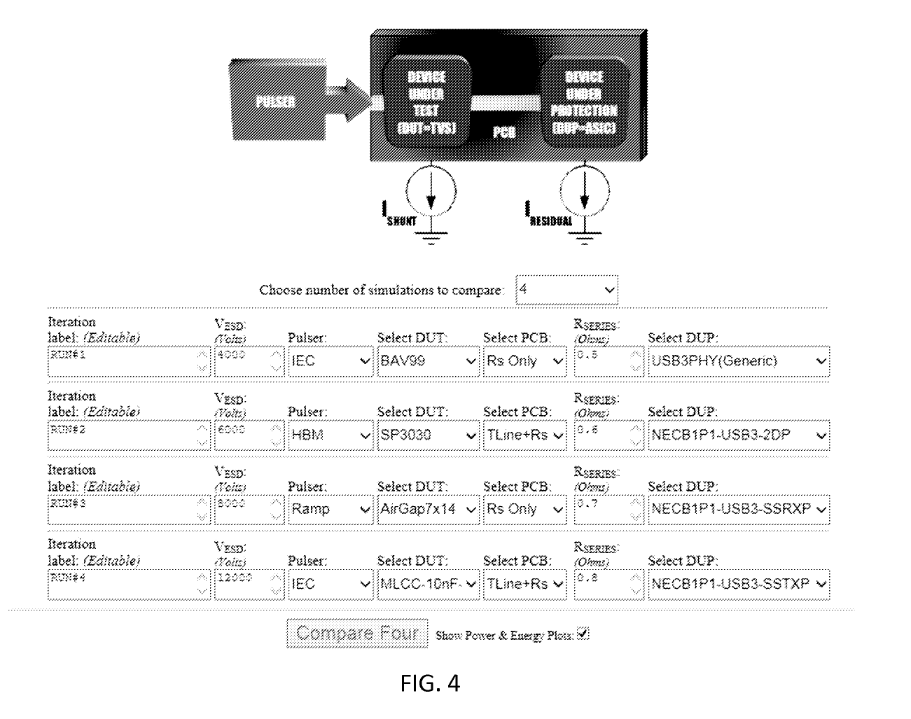

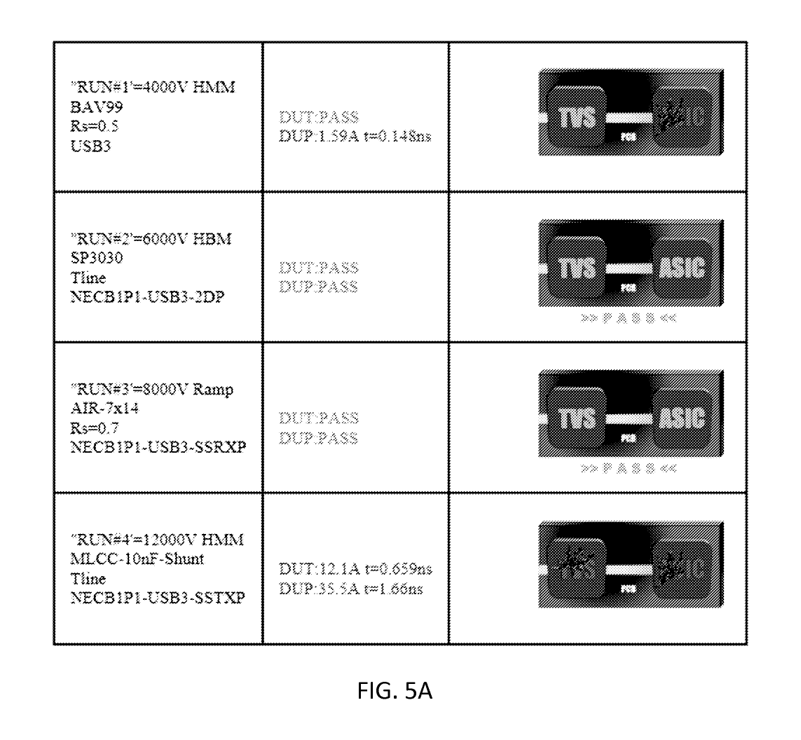

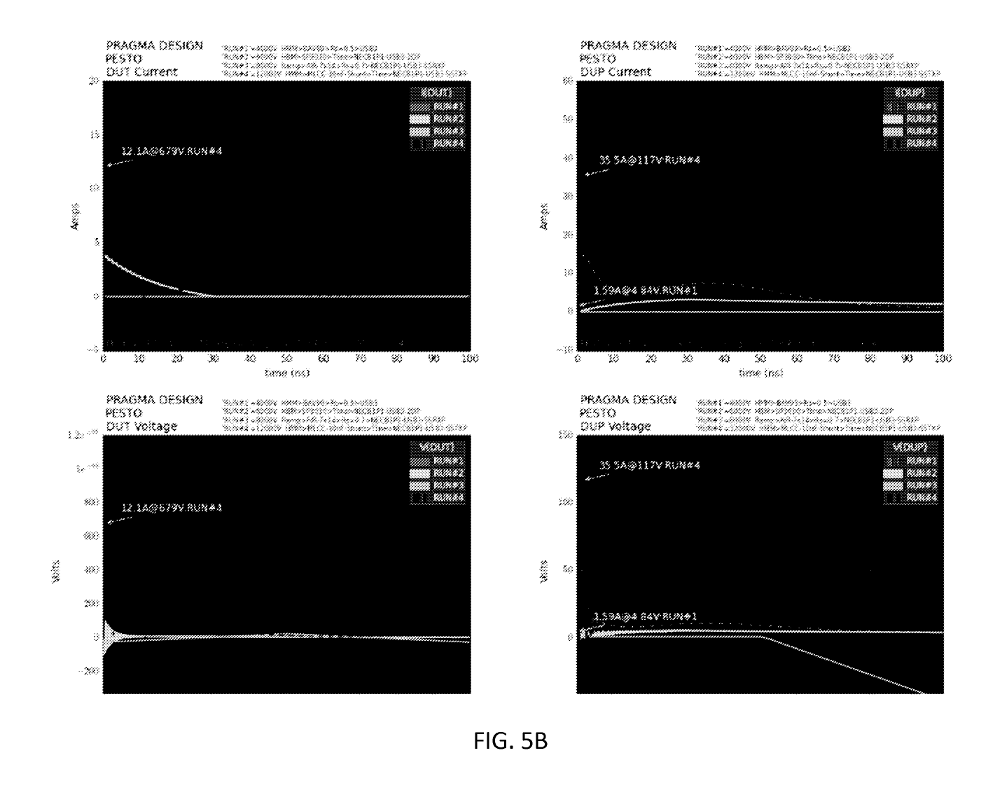

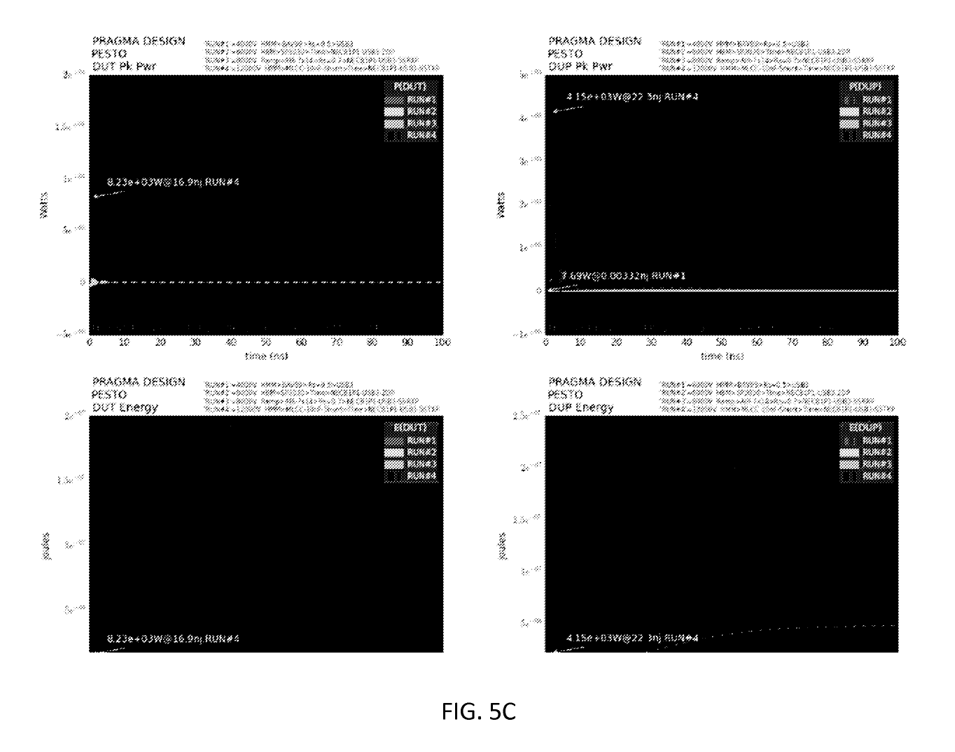

FIG. 4 shows an exemplary embodiment of ESD/EOS simulation tool and example input parameters. FIG. 5A through 5C show example simulation results that were produced using the input parameters shown in FIG. 4. The simulation results include indications of whether the device under test (DUT) passed or failed, device under protection (DUP) passed or failed, and power and energy plots.

In an exemplary embodiment, there is provided a method of optimizing and/or predicting and/or calculating and/or simulating combined system transient robustness and/or susceptibility. In this example, the method may include hiding the model parameters behind the client-server partitioning. The method may also or instead include performing simulations of failures, destruction, damage, destruction/damage levels and/or when outside safe operating parameters. Instead of performing simulations based on models created to describe only conditions up to and including maximum limits, example embodiments disclosed herein may create or include new extended models that describe actual operation between maximum limits and typical destruction/damage levels. Such simulations using extended models may thus provide very useful information, as manufacturers usually include margins that are not disclosed.

Example embodiments may allow or provide an analysis of protection component interactions. Example embodiments may allow various combinations to be tested relatively quickly and/or easily to thereby allow the user to choose better protection devices and design strategies.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1 - 2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances. Whether or not modified by the term “about”, the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for numerical simulation of one or more Electrostatic Discharge (ESD) and/or Electrical Overstress (EOS) events applied to one or more component devices under test or devices under protection, the system is configured to hide one or more parameters of a model used in the numerical simulation behind a client-server partitioning to thereby restrict distribution of the one or more parameters of the model.

2. The system of claim 1, wherein the system is configured such that models are partitioned and isolated to allow each model to be independent and protected from disclosure while providing retained control of each model by its respective contributor.

3. The system of claim 1, wherein the system includes a platform configured to allow multiple users to utilize the platform simultaneously to select independent combinations of models and simulation parameters, to execute simulations, and to view, store, and retrieve results independently, whereby a central or distributed repository of models can be used by system integrators to compare and contrast results in various combinations.

4. The system of claim 1, wherein the system is configured to provide access to one or more centralized resources for industry standard nodal circuit or finite element analysis numerical simulation of electromagnetic events while hiding one or more parameters of a model used in the simulation behind a client-server partitioning to thereby restrict distribution of the one or more model parameters.

5. The system of claim 1, wherein the system is configured to segment an architecture such that elements of a front-end interface and back-end processing are distributed across multiple network or ownership domain boundaries.

6. The system of claim 1, wherein the system comprises an ESD/EOS system level simulation tool.

7. The system of claim 1, wherein the system is configured to concatenate selected component models, aggressor (zap source) models, circuit board and interstitial parasitic elements relevant to the simulation after receiving a session's simulation configuration request.

8. A method for numerical simulation of one or more Electrostatic Discharge (ESD) and/or Electrical Overstress (EOS) events applied to one or more component devices under test or devices under protection, the method comprising hiding one or more parameters of a model used in the numerical simulation behind a client-server partitioning to thereby restrict distribution of the one or more parameters of the model.

9. The method of claim 8, wherein the method includes partitioning and isolating models such that each model is independent and protected from disclosure while providing retained control of each model by its respective contributor.

10. The method of claim 8, wherein the method includes providing access to one or more centralized resources for industry standard nodal circuit or finite element analysis numerical simulation of electromagnetic events while hiding the one or more parameters of the model used in the simulation behind the client-server partitioning to thereby restrict distribution of the one or more model parameters.

11. The method of claim 8, wherein the method includes providing a platform for multiple users to utilize the platform simultaneously to select independent combinations of models and simulation parameters, to execute simulations, and/or to view, store, and retrieve results independently.

12. The method of claim 11, wherein the platform enables the use of a central or distributed repository of device models by system integrators to compare and contrast results in various combinations.

13. The method of claim 8, wherein the method includes simultaneously monitoring and analyzing a plurality of failure modes and mechanisms and allowing extraction of accurate relevant pass/fail results.

14. The method of claim 8, wherein the method includes segmenting an architecture such that elements of a front-end interface and elements of a back-end processing are distributed across multiple network or ownership domain boundaries.

15. The method of claim 8, wherein the method includes isolating and protection model libraries within a back-end simulation site.

16. The method of claim 8, wherein the method includes concatenating selected component models, aggressor (zap source) models, circuit board and interstitial parasitic elements relevant to the simulation after receiving a session's simulation configuration request.

17. The method of claim 8, wherein the method includes performing simulations of failures, destruction, damage, destruction/damage levels, and/or when outside safe operating parameters.
